(19) United States
(12) Patent Application Publication
(10) Pub. No.: US 2026/0257406 A1
(43) Pub. Date: Sep. 3, 2026

(54) INJECTION MOULDING TOOL WITH MULTI-PART MOULD INSERT FRAME

(71) Applicant: FOSTAG Formenbau AG, Stein am Rhein (CH)

(72) Inventor: Rolf MÜHLEMANN, Schlattingen (CH)

(73) Assignee: FOSTAG Formenbau AG, Stein am Rhein (CH)

(21) Appl. No.: 18/875,250

(22) PCT Filed: May 23, 2023
(86) PCT No.: PCT/CH2023/050017

§ 371 Date: Dec. 16, 2024

(30) Foreign Application Priority Data
Jun. 17, 2022 (CH) CH000725/2022

(51) Int. Cl. B29C 45/22; B29C 45/27

(52) U.S. Cl. CPC B29C 45/22; B29C 45/27; B29C 2045/2779

(57) ABSTRACT

In an injection moulding tool comprising a mould insert frame (3) for the accommodation of a multiple nozzle head (4) and a plurality of mould inserts (7), each having a cavity formed therein, each of which can be supplied with plastic melt via the multiple nozzle head (4); wherein the mould insert frame (3) has a central recess (4) extending in an axial direction (A), in which the multiple nozzle head (3) is accommodated, and a plurality of peripheral recesses (5) arranged around the central recess (4), and extending in the axial direction (A), in each of which recesses one of the plurality of mould inserts (7) is accommodated; provision is made that the mould insert frame (3) comprises a central frame part (31, 31′) with the central recess (4), and at least one peripheral fixing part (32, 32′) that can be removed from the central frame part (31, 31′); wherein the plurality of peripheral recesses (5) are formed by the central frame part (31, 31′) and the at least one peripheral fixing part (32, 32′); wherein a line of separation (T), between the central frame part (31, 31′) and the at least one removable peripheral fixing part (32, 32′), extends through the respective peripheral recess (5), such that when the peripheral fixing part (32, 32′) has been removed, the mould insert (7) can be removed from the central frame part (31, 31′) in a direction (R) at right angles to the axial direction (A) of the multiple nozzle head (3).

### TECHNICAL FIELD

The invention relates to an injection moulding tool with a mould insert frame for the accommodation and mounting of a multiple nozzle head, and a plurality of mould inserts arranged around the multiple nozzle head.

### TECHNICAL BACKGROUND

Injection moulding tools with a plurality of mould inserts, which are supplied with a plastic melt via a multiple nozzle head, usually have a mould insert frame, in which the multiple nozzle head and the plurality of mould inserts are accommodated and mounted. For this purpose, the mould insert frame has a central recess for the multiple nozzle head, extending in a vertical direction, and a plurality of peripheral recesses arranged evenly around the central recess for the mould inserts, which likewise extend in an axial direction. The axial direction is also the closing or opening direction of the injection moulding tool.

The multiple nozzle head comprises a primary melt channel, which at one end of the multiple nozzle head branches into a plurality of secondary melt channels, which run essentially at right angles to the axial direction and open laterally into the mould insert. In each case the secondary melt channel is connected at a proximal end to the primary melt channel, and at a distal end is connected by a nozzle tip attached to the nozzle head to an antechamber. The antechamber is formed partly by the multiple nozzle head and partly by the respective mould insert; these are connected to each other in a sealed manner. At the same time the nozzle tip usually extends into a corresponding recess in the mould insert. Accordingly, the mould inserts can be positioned and fixed very precisely with respect to the multiple nozzle head by means of the respective recesses.

During normal operation of the injection mould, individual mould inserts may need to be serviced and cleaned. To remove the mould insert to be cleaned, the appropriate mould insert, together with the multiple nozzle head, and all other mould inserts, must be lifted out of the injection moulding tool, that is to say, out of the recesses in the mould insert frame, in an axial direction. The defective mould insert can then be removed from the multiple nozzle head in a direction at right angles to the axial direction. The assembly and reinsertion of the mould inserts and the multiple nozzle head into the injection moulding tool is extremely time-consuming and requires a great deal of skill, because all the mould inserts must be precisely aligned with the multiple nozzle head before all the elements can together be inserted into the corresponding recesses in the insert frame. There is also a high risk of damaging the nozzle tips or other parts in this procedure.

In order to enable an easier assembly and disassembly of a mould insert, WO20227817A1 proposes that the nozzle tip be designed to be detachable in the axial direction. The mould insert can thus be removed in the axial direction together with the nozzle tip. However, if there is still solid plastic in the nozzle, and in particular in the nozzle tip and the corresponding antechamber, a cold disassembly of the mould insert is almost impossible. The seal between the nozzle tip and the multiple nozzle head presents another problem. Even a very small amount of play in the nozzle tip inevitably leads to leaks. In addition, instead of a conventional multiple nozzle head that is commercially available, a specially designed multiple nozzle head, with a nozzle tip that can be removed in the axial direction, must be used.

EP0743157 and WO09124865 each describe systems with individually removable nozzle tips, in order that the mould insert can subsequently be removed. In the case of EP0743157, an upper part of the mould insert must also be removed beforehand, as a result of which further leaks can occur. With these systems, cold disassembly of a mould insert is still almost impossible if solid plastic residues are present.

### SUMMARY OF THE INVENTION

One object of the invention is to provide an injection moulding tool that does not have the above-cited disadvantages. This object is achieved by an injection moulding tool with the features of claim 1.

The injection moulding tool comprises a mould insert frame for the accommodation of a multiple nozzle head, and a plurality of mould inserts, each having a cavity formed therein, each of which inserts can be supplied with plastic melt via the multiple nozzle head. The mould insert frame has a central recess extending in an axial direction, in which the multiple nozzle head is accommodated, and a plurality of peripheral recesses are arranged around the central recess and extending in the axial direction, in each of which recesses one of the plurality of mould inserts is accommodated. The mould insert frame comprises a central frame part with the central recess, and at least one peripheral fixing part that can be removed from the central frame part. The plurality of peripheral recesses are formed by the central frame part and the at least one peripheral fixing part. A line of separation between the central frame part and the at least one removable peripheral fixing part extends through the respective peripheral recess, such that, when the peripheral fixing part has been removed, the mould insert can be removed from the central frame part in a direction at right angles to the axial direction of the multiple nozzle head.

Such a multi-part mould insert frame, which can be accommodated in a tool plate of the injection moulding tool, allows an easy removal of a mould insert from the corresponding nozzle tip of the multiple nozzle head in a radial direction. By this means a cold disassembly is made possible. In addition, the central frame part ensures that the remaining, non-removed, mould inserts are held on the multiple nozzle head in the correct position. For a subsequent re-assembly, no laborious alignment of the individual mould inserts with the respective peripheral recesses is necessary, as is the case with conventional one-piece mould insert frames. The system can also be combined with conventional multiple nozzle heads without the need for complex removable nozzle tips.

Preferred types of embodiments of the invention are specified in the dependent claims.

In some embodiments, the central frame part can form an inner, proximal (i.e. closer to the centre, that is to say, to the central recess) peripheral surface of the plurality of peripheral recesses, and the at least one peripheral fixing part can form an outer, distal (i.e. further away from the centre, that is to say, from the central recess) peripheral surface of the plurality of peripheral recesses. The two peripheral surfaces form the peripheral recess in which the mould insert is positioned and fixed exactly opposite the nozzle tip. Here the part of the recess in the central frame part and its proximal peripheral surface are also designed such that the mould insert can be precisely positioned and held in it. As a rule, the proximal peripheral surface on the central frame part spans a maximum of 180 degrees of the peripheral recess, such that the moulding unit can be removed in a (radial) direction at right angles to the axial direction.

In some embodiments, the peripheral fixing part can be formed by a tool plate of the injection mould, into which the central frame part can be inserted, together with the multiple nozzle head and the plurality of mould inserts. In the course of disassembly, the central frame part, together with the multiple nozzle head and the mould inserts, are lifted out of the tool plate, that is to say, the peripheral fixing part, in an axial direction, using a suitable tool. The mould insert can then be removed from the central frame part in a direction at right angles to the axial direction.

In some embodiments, the mould insert frame can comprise a single peripheral fixing part surrounding the central frame part, which, together with the central frame part, the multiple nozzle head, and the multiple mould inserts, can be inserted into a tool plate of the injection mould. In the course of disassembly, the mould insert frame is first pulled out of the mould plate in an axial direction, using a suitable tool. The central frame part, together with the multiple nozzle head, and the mould inserts, are then pulled out of the peripheral fixing part in an axial direction, using a suitable tool. The mould insert can then be removed from the nozzle tip in a direction at right angles to the axial direction from the central frame part.

In some embodiments, the mould insert frame can comprise a plurality of peripheral fixing parts, which, together with the central frame part, the multiple nozzle head, and the plurality of mould inserts, can be inserted into a tool plate of the injection moulding tool. The plurality of peripheral fixing parts can be arranged in corresponding recesses in the central frame part. The plurality of peripheral fixing parts can be individually removable from the central frame part in a direction at right angles to the axial direction. In the course of disassembly, the mould insert frame is first pulled out of the mould plate in an axial direction, using a suitable tool. One of the plurality of peripheral fixing parts can then be removed from the central frame part. The mould insert can then be removed from the nozzle tip, in a direction at right angles to the axial direction, from the central frame part.

In some embodiments, the plurality of peripheral recesses can be circular, with one or a plurality of circular cylindrical sections.

In some embodiments, an outer contour of the mould insert frame can be cylindrical, preferably with a plurality of circular cylindrical sections. The mould insert frame can be accommodated in a corresponding recess in the tool plate.

In some embodiments, the peripheral recess can have a circumferential shoulder, against which the mould insert lies in the installed state, and on which the mould insert is guided during assembly or disassembly. The mould insert can have a corresponding complementary shoulder.

In some embodiments, between the central recess and the plurality of peripheral recesses, the central frame part can in each case have a recess in which a nozzle tip of the multiple nozzle head is arranged.

In some embodiments, the peripheral recesses can be evenly distributed around the central recess. Typically, they are arranged in a circle. The mould insert frame can have 2 to 8 recesses, and correspondingly 2 to 8 mould inserts, each of which is connected to a central multiple nozzle head.

In some embodiments, the line of separation can be of circular design, and can divide the peripheral recesses into two approximately equal parts. This is particularly advantageous in the case of an essentially annular peripheral fixing part.

In some embodiments, the central frame part can have a plurality of elongate, radially outwardly open recesses, with essentially parallel side walls, into each of which one of the plurality of peripheral fixing parts can be inserted, thereby forming a peripheral recess. The line of separation between the central frame part and the peripheral fixing part runs along the essentially parallel side walls of the recess.

In some embodiments, the plurality of mould inserts can be held in position in the peripheral recesses of the central frame portion, even if the peripheral fixing part has been removed.

In some embodiments, the multiple nozzle head can have a primary melt channel, which can run in an axial direction, and for each cavity, a secondary melt channel branching off from the primary melt channel, which can run in a radial direction. The secondary melt channel can be connected to the primary melt channel at a proximal end, and to a cavity at a distal end, by a nozzle tip attached to the nozzle head.

In some embodiments, the multiple nozzle head can have a plurality of nozzle tips for the lateral injection of the plurality of cavities.

In some embodiments, the injection moulding tool can have a cover plate, with which the mould inserts, and/or the multiple nozzle head, are fixed in the respective recesses.

In some embodiments, the plurality of mould inserts can have a means of attachment for a suitable tool on the side opposite the respective nozzle tip, so that the plurality of mould inserts can be pulled out of the central frame part with the suitable tool in a direction at right angles to the axial direction. The means of attachment can be, for example, a bore with an internal thread, into which a suitable tool can be screwed. The means of attachment can also have one or a plurality of openings, into which a suitable tool can engage and clamp itself.

The injection moulding tool can also have a plurality of mould insert frames with multiple nozzle heads, and a plurality of mould inserts, as described above.

### BRIEF DESCRIPTION OF THE DRAWINGS

The invention will be explained in more detail below by means of examples of embodiment in the context of the drawing(s). Here:

FIG. 1 shows a view in perspective of an injection moulding tool with a two-part mould insert frame;

FIG. 2 shows a view in perspective of the injection moulding tool from FIG. 1 with the mould insert frame removed;

FIG. 3 shows a plan view of the two-part mould insert frame from FIG. 1;

FIG. 4 shows a view in perspective of the two-part mould insert frame from FIG. 1 with the central frame part removed;

FIG. 5 shows a view in perspective of the central frame part from FIG. 1 with the mould insert removed;

FIG. 6 shows an exploded view in perspective of the mould insert frame from FIG. 1 with a multiple nozzle head and a mould insert;

FIG. 7 shows a view in perspective of an injection moulding tool with the multi-part mould insert frame removed;

FIG. 8 shows a plan view of the multi-part mould insert frame from FIG. 7;

FIG. 9 shows a view in perspective of the multi-part mould insert frame from FIG. 7 with the peripheral fixing part removed;

FIG. 10 shows a view in perspective of the multi-part mould insert frame from FIG. 7 with the mould insert removed;

FIG. 11 shows a view in perspective of the central frame section from FIG. 7 with the multiple nozzle head removed.

### EMBODIMENTS OF THE INVENTION

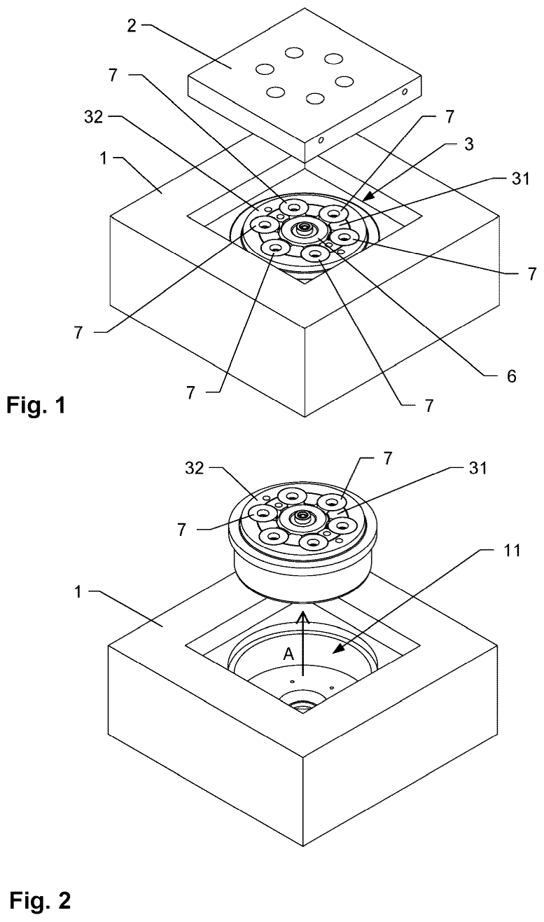

FIG. 1 shows an injection moulding tool, that is to say, a mould plate 1, of an injection moulding tool with a plurality of mould inserts 7. In the form of embodiment shown, the mould inserts 7 are arranged in a circle around a multiple nozzle head 6, which supplies each of the cavities of the respective mould inserts 7 with molten plastic. An antechamber for the plastic melt is formed by a recess in the mould insert 7, into which a nozzle tip 61 of the multiple nozzle head 6 projects.

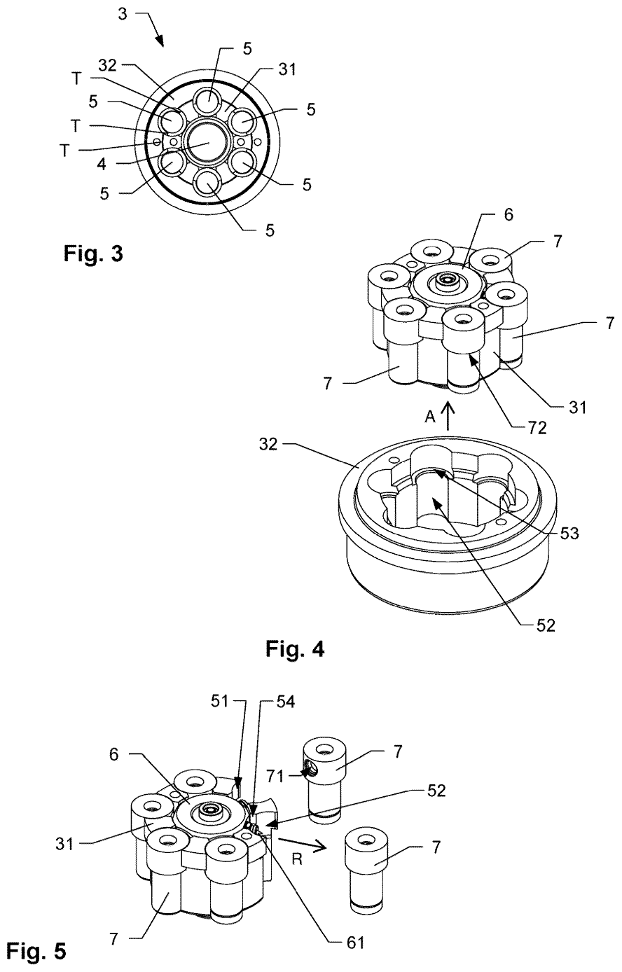

The multiple nozzle head 6 and the plurality of mould inserts 7 must therefore be arranged such that they seal against each other in the region of the antechamber. This is usually achieved by holding the multiple nozzle head 6 and the multiple mould inserts 7 in a mould insert frame 3, and in this manner fixing them in the correct position relative to each other. For this purpose, the mould insert frame 3 has a central recess 4 for the multiple nozzle head 6, and a plurality of peripheral recesses 5 for the multiple mould inserts 7. These recesses 4, 5 and their arrangement, amongst other items, can clearly be seen in FIG. 3. FIG. 3 shows a plan view of the two-part mould insert frame 3 from FIG. 1.

The mould insert frame 3, the multiple nozzle head 6 and the mould inserts 7, which are installed in a tool plate, e.g. in a holder 11 for the mould insert frame 3, can also be provided with, and fastened down with, a cover plate 2.

In the form of embodiment shown in FIG. 1, a two-part mould insert frame 3 is shown. The latter has a central frame part 31 and an annular peripheral fixing part 32. The central recess 4 is designed in the centre of the central frame part 32 (see FIG. 3). The plurality of peripheral recesses 5 are arranged in a circle around the central recess 5, and are formed both by an outer contour of the central frame part 31 and an inner contour of the peripheral fixing part 32 (see FIG. 3), such that a line of separation T between the two frame parts 31, 32 runs through the peripheral recesses 5. Here the central frame part 31 forms a proximal peripheral surface 51 of the peripheral recess 5, which surface spans a maximum of 180 degrees of the peripheral recess 5. The peripheral fixing part 32 forms a distal peripheral surface 52 of the peripheral recess 5, which surface spans a maximum of 180 degrees of the peripheral recess 5. These peripheral surfaces 51, 52 can clearly be seen in FIGS. 3 to 6.

FIG. 2 shows a situation in which the mould insert frame 3, comprising the inner and peripheral fixing parts 31, 32, has been removed, together with the multiple nozzle head 6 and the multiple mould inserts 7 accommodated therein. For this purpose, the mould insert frame 3 is lifted out of the holder 11 of the tool plate in the axial direction A, using a suitable tool.

In FIG. 4, the mould insert frame 3 is shown in a situation in which the central frame part 31 has been removed, together with the multiple nozzle head 6 and the multiple mould inserts 7 accommodated therein. For this purpose, the central frame part 31 with the multiple mould inserts 7 is lifted out of the outer annular frame part 32 in the axial direction A, using a suitable tool. The peripheral recesses are generally circular cylindrical in shape, whereby sections can have different diameters, such that a circumferential shoulder 53 is formed. The mould insert 7, which is likewise circular cylindrical in shape, has a complementary shoulder 72, with which it can rest on the circumferential shoulder 53 of the peripheral recess 5 in the installed state, and can be guided during assembly and disassembly.

FIG. 5 shows the central frame part 31 with the multiple nozzle head 6 and the multiple mould inserts 7. Two of the plurality of mould inserts are removed, in that they have been pulled out of the corresponding peripheral recesses 5 in the radial direction R,, i.e. at right angles to the axial direction A. In FIG. 5, a nozzle tip 61 of the multiple nozzle head 6, and an antechamber 71 of a mould insert 7, can be seen. The configuration of the central frame part 31 and the peripheral recesses 5 allows the mould insert 7 to be removed from the nozzle tip 61, without the need to remove the latter. The projecting nozzle tip 71 is accommodated in a recess 54 of the central frame part 31, which forms an aperture between the central recess 4 and the respective peripheral recesses 5.

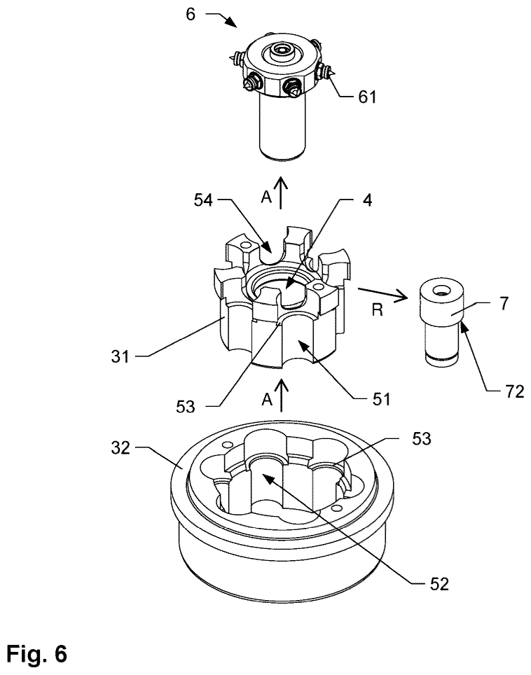

Finally, in an exploded view FIG. 6 shows the mould insert frame 3 in FIG. 1 with the multiple nozzle head 6 and a mould insert 7.

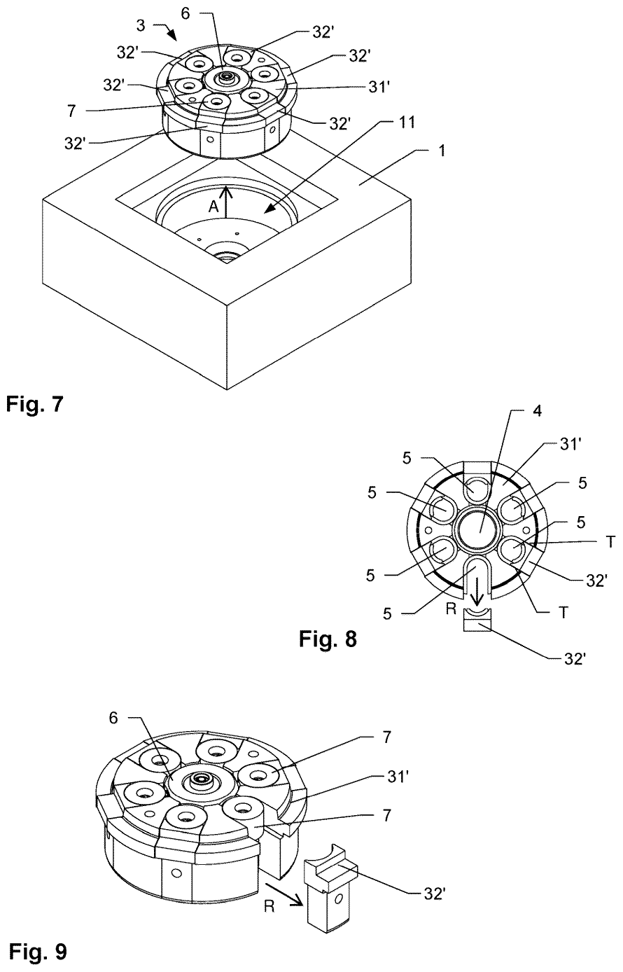

In contrast to the form of embodiment in FIG. 1, FIG. 7 shows an embodiment of the injection moulding tool with a removed multi-part mould insert frame 3, which comprises a central frame part 31′ and a plurality of peripheral fixing parts 32′. Each peripheral fixing part 32′ holds one of the plurality of mould inserts 7 in the corresponding peripheral recess 7; these are likewise arranged around the central recess 4. These recesses 4, 5 and their arrangement, amongst other items, can clearly be seen in FIG. 8. FIG. 8 shows a plan view of the multi-part mould insert frame 3 from FIG. 7.

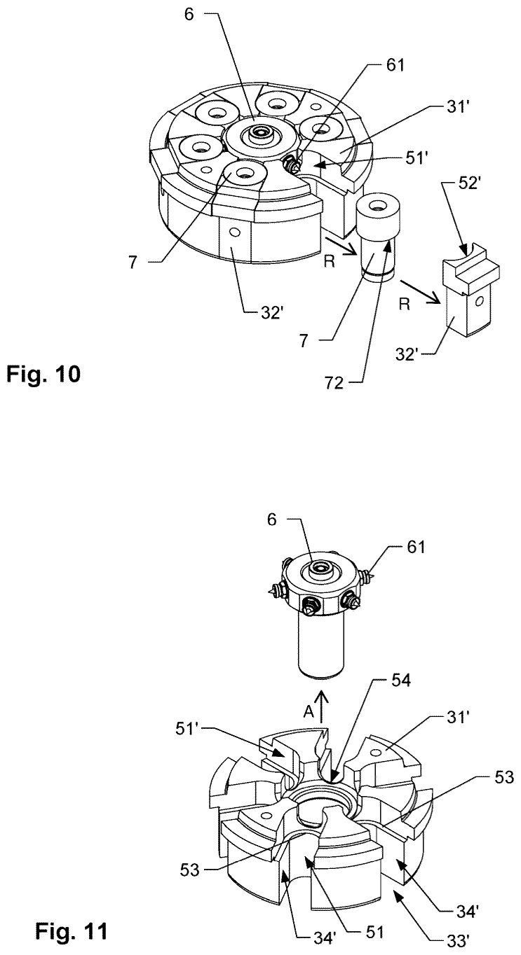

The central frame part 31′ has a plurality of elongate, radially outwardly open recesses 33′ with essentially parallel side walls 34′ (see FIG. 10), into each of which one of the plurality of peripheral fixing parts 32′ can be inserted, thereby forming one of the plurality of peripheral recesses 5.

As in the form of embodiment shown in FIG. 1, the peripheral recess 5 is formed by the central frame part 31′ and the peripheral fixing part 32′, and likewise has a proximal peripheral surface 51 formed by the central frame part 31′, and a distal peripheral surface 52 formed by the peripheral fixing part 32′.

In contrast to the embodiment in FIG. 1, when removing a mould insert 7, the inner frame part is not lifted axially out of the peripheral fixing part; instead a peripheral fixing part 31′ is removed from the recess 33′ of the central frame part 31′ in the radial direction R at right angles to the axial direction A. This releases the mould insert 7, and the latter can likewise be removed in the radial direction R. FIG. 9 shows a multi-part mould insert frame 3 with the peripheral fixing part 32′ removed. FIG. 10 shows a multi-part mould insert frame 3 with the mould insert 7 removed.

Finally, FIG. 11 shows an empty central frame part 31′ with the multiple nozzle head 6 removed.

### REFERENCE SIGNS

1 Tool plate
11 Holder for mould insert frame
2 Cover plate
3 Mould insert frame
31, 31′ Central frame part
32, 32′ Peripheral fixing part
33′ Recess
34′ Side wall
4 Central recess
5 Peripheral recess
51 Proximal peripheral surface
52 Distal peripheral surface
53 Shoulder
54 Recess
6 Multiple nozzle head
61 Nozzle tip
7 Mould insert
71 Antechamber
72 Shoulder
A Axial direction
R Radial direction
T Line of separation

1-15. (canceled)

16. An injection moulding tool, comprising a mould insert frame for accommodation of a multiple nozzle head, and a plurality of mould inserts, each having a cavity formed therein, each of which mould inserts can be supplied with plastic melt via the multiple nozzle head; wherein
wherein the mould insert frame has a central recess extending in an axial direction, in which the multiple nozzle head is accommodated, and a plurality of peripheral recesses arranged around the central recess and extending in the axial direction, in each of which peripheral recesses one of the plurality of mould inserts is accommodated;
wherein the mould insert frame comprises a central frame part with the central recess, and at least one peripheral fixing part that can be removed from the central frame part;
wherein the plurality of peripheral recesses is formed by the central frame part and the at least one peripheral fixing part;
a line of separation between the central frame part and the at least one peripheral fixing part extends through the respective peripheral recess, such that, when the peripheral fixing part has been removed, the mould insert can be removed from the central frame part in a direction at right angles to the axial direction of the multiple nozzle head.

17. The injection moulding tool of claim 16, wherein the central frame part forms an inner, proximal peripheral surface of the plurality of peripheral recesses, and the at least one peripheral fixing part forms an outer, distal peripheral surface of the plurality of peripheral recesses.

18. The injection moulding tool of claim 16, wherein the at least one peripheral fixing part is formed by a tool plate of the injection moulding tool, into which the central frame part can be inserted, together with the multiple nozzle head and the plurality of mould inserts.

19. The injection moulding tool of claim 16, wherein the at least one peripheral fixing part comprises a single peripheral fixing part, which surrounds the central frame part and which, together with the central frame part, the multiple nozzle head, and the plurality of mould inserts, can be inserted into a tool plate of the injection moulding tool.

20. The injection moulding tool of claim 16, wherein the at least one peripheral fixing part comprises a plurality of peripheral fixing parts, which, together with the central frame part, the multiple nozzle head, and the plurality of mould inserts, can be inserted into a tool plate of the injection moulding tool.

21. The injection moulding tool of claim 20, wherein the plurality of peripheral fixing parts are removable individually from the central frame part in a direction at right angles to the axial direction.

22. The injection moulding tool of claim 16, wherein the plurality of peripheral recesses are of circular design, with one or a plurality of circular cylindrical sections.

23. The injection moulding tool of claim 16, wherein each of the plurality of peripheral recesses has a circumferential shoulder, against which a respective one of the plurality of mould inserts lies in the installed state, and on which the mould insert is guided in the course of assembly or disassembly.

24. The injection moulding tool of claim 16, wherein the central frame part has a tip recess in each case between the central recess and the plurality of peripheral recesses, in each of which a nozzle tip of the multiple nozzle head is arranged.

25. The injection moulding tool of claim 16, wherein the plurality of peripheral recesses are arranged in an even distribution around the central recess.

26. The injection moulding tool of claim 16, wherein the line of separation is of circular design, and divides the plurality of peripheral recesses into two approximately equal parts.

27. The injection moulding tool of claim 20, wherein the central frame part has a plurality of elongate, radially outwardly open recesses with substantially parallel side walls, into each of which one of the plurality of peripheral fixing parts can be inserted, thereby forming one of the plurality of peripheral recesses.

28. The injection moulding tool of claim 16, wherein the plurality of mould inserts are held in position in the peripheral recesses of the central frame part, even when the at least one peripheral fixing part has been removed.

29. The injection moulding tool of claim 16, wherein the multiple nozzle head has a plurality of nozzle tips for lateral injection into the plurality of cavities.

30. The injection moulding tool of claim 16, wherein the plurality of mould inserts each have a means of attachment for a suitable tool on the side opposite the respective nozzle tip, such that the plurality of mould inserts can, with tool assistance, be pulled out of the central frame part in the direction at right angles to the axial direction.
